(19) United States
(12) Patent Application Publication
(10) Pub. No.: US 2024/0276346 A1
(43) Pub. Date: Aug. 15, 2024

(54) COMMUNICATION APPARATUS, CONTROL METHOD, AND NON-TRANSITORY COMPUTER-READABLE STORAGE MEDIUM

(71) Applicant: CANON KABUSHIKI KAISHA, Tokyo (JP)

(72) Inventor: Shiho Sekiguchi, Kanagawa (JP)

(21) Appl. No.: 18/428,307

(22) Filed: Jan. 31, 2024

(30) Foreign Application Priority Data
Feb. 15, 2023 (JP) 2023-021869

(51) Int. Cl. H04W 48/02; H04W 76/10; H04W 84/12; H04W 92/10

(52) U.S. Cl. CPC H04W 48/02; H04W 76/10; H04W 84/12; H04W 92/10

(57) ABSTRACT

A communication apparatus detects a state of a wireless communication interface of the communication apparatus, enables the wireless communication interface by executing restriction processing of restricting establishment of connection via the wireless communication interface in a case where the communication apparatus detects a state in which the wireless communication interface is disabled, establishes wireless connection to a first another communication apparatus via the enabled wireless communication interface, and transmits, to the first other communication apparatus, via the wireless connection, connection information usable for connection to a second another communication apparatus different from the first other communication apparatus.

### BACKGROUND OF THE INVENTION

### Field of the Invention

The present invention relates to a communication apparatus, a control method, and a non-transitory computer-readable storage medium.

### Description of the Related Art

With respect to a communication apparatus having a connection function to a wireless local area network (wireless LAN), there is known a technique for controlling enabling and disabling of the wireless LAN connection function in accordance with the state of the communication apparatus (Japanese Patent No. 6432231).

### SUMMARY OF THE INVENTION

With respect to a communication apparatus having a wireless LAN connection function, there is provided a technique for readily connecting the communication apparatus to an access point (to be referred to as an AP hereinafter) by temporarily connecting an information processing apparatus and the communication apparatus by wireless direct connection. More specifically, when the information processing apparatus transmits wireless setting information of the AP to the communication apparatus via wireless direct communication, the communication apparatus establishes connection to the AP. This does not require a user to operate the communication apparatus and the AP, thereby implementing simpler wireless setup processing. However, in this technique, if the wireless LAN interface of the information processing apparatus is disabled, the information processing apparatus cannot execute the setup processing.

Furthermore, an Operating System (to be referred to as an OS hereinafter) holds a wireless profile of an AP to which the apparatus has been connected before by the wireless LAN interface. The OS has a function of automatically performing connection, using the wireless profile, to the AP to which the apparatus has been connected before, when enabling the wireless LAN interface. Therefore, by enabling the wireless LAN interface of the information processing apparatus, the information processing apparatus can be reconnected to an unintended network by the function of the OS. In the setup processing, when the information processing apparatus preferentially transmits information of the currently connected AP to the communication apparatus, it may transmit the information of the unintentionally reconnected AP. However, in a case where the wireless LAN interface is intentionally disabled, the user does not always want to connect the communication apparatus to the automatically reconnected AP. For example, if a setting is made to automatically perform reconnection to a pay-as-you-go network, the user can disable the wireless LAN interface to suppress a charge amount.

As described above, in a communication apparatus whose wireless LAN interface is disabled, when the user performs reconnection to an unintended network, convenience of wireless setup processing may degrade.

The present invention has been made in consideration of the above problem, and provides a technique for improving convenience in wireless setup processing.

To solve the above problem, a communication apparatus according to the present invention comprises: a detection unit configured to detect a state of a wireless communication interface of the communication apparatus; an enabling unit configured to enable the wireless communication interface by executing restriction processing of restricting establishment of connection via the wireless communication interface in a case where the detection unit detects a state in which the wireless communication interface is disabled; an establishment unit configured to establish wireless connection to a first another communication apparatus via the enabled wireless communication interface; and a transmission unit configured to transmit, to the first other communication apparatus, via the wireless connection, connection information usable for connection to a second another communication apparatus different from the first other communication apparatus.

Further features of the present invention will become apparent from the following description of exemplary embodiments (with reference to the attached drawings).

### BRIEF DESCRIPTION OF THE DRAWINGS

FIGS. 1A and 1B are views each showing an example of a system configuration according to an embodiment;

FIG. 2 is a block diagram showing an example of hardware arrangements according to the embodiment;

FIG. 3 is a flowchart illustrating an example of processing of connecting a printer to a network according to the first embodiment;

FIGS. 4A and 4B are flowcharts illustrating an example of processing of determining whether it is possible to execute P2P wireless setting processing according to the first embodiment;

FIG. 5 is a table showing combinations each indicating whether it is possible to execute P2P wireless setting processing according to the first embodiment;

FIG. 6 is a flowchart illustrating an example of reconnection control processing according to the first embodiment;

FIGS. 7A and 7B are flowcharts each illustrating an example of P2P wireless setting processing according to the first embodiment;

FIG. 8 is a flowchart illustrating an example of wireless setting instruction processing according to the first embodiment;

FIG. 9 is a flowchart illustrating an example of setting wait processing according to the first embodiment;

FIGS. 10A to 10D are views each showing an example of a screen displayed on a display device 208 of a PC 101 according to the embodiment;

FIGS. 11A and 11B are views each showing an example of a screen displayed on the display device 208 of the PC 101 according to the embodiment;

FIG. 12 is a view showing an example of a screen displayed on the display device 208 of the PC 101 according to the embodiment; and

FIGS. 13A to 13C are views each showing an example of a screen displayed on the display device 208 of the PC 101 according to the embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

A personal computer (PC) and a printer will be exemplified as communication apparatuses according to an embodiment but a tablet terminal and other communication apparatuses may be used.

In this embodiment, to perform communication by establishing wireless infrastructure connection between a PC and a printer via an access point (AP), wireless setup processing of transmitting a wireless setting instruction from the PC to the printer is executed. The wireless infrastructure connection indicates a method of performing connection via the AP. For example, the PC and the printer are connected to the same AP to perform communication. With the wireless setup processing, the PC can temporarily be connected to the printer in a wireless setting mode (to be described later), transmit, to the printer, information concerning an AP to be connected, and connect the printer to the AP. For example, the PC acquires a list of APs connectable to the printer, automatically determines whether the list includes the AP connected to the PC, and transmits, to the printer, information to be used for connection to the AP. Then, the printer is connected to the AP using the information. The information used for connection to the AP includes specification information (an SSID or the like) of the AP and authentication information (a password or the like) used for authentication processing of the AP.

At this time, in order for the PC to establish temporary connection to the printer in the wireless setting mode, the PC needs to have a wireless LAN interface. However, the PC may not have a wireless communication interface such as a wireless LAN interface or such interface may be disabled. In this case, since the PC cannot establish temporary connection to the printer in the wireless setting mode, the PC cannot transmit a wireless setting instruction to the printer. In this case, the user inputs setting information of an AP to a screen of the printer, thereby connecting the printer to the AP. However, in a case of an inexpensive printer, convenience of input of characters such as a password is low due to the restriction of an output interface such as a small screen and the restriction of an input interface such as a small number of provided key buttons, and thus connection processing may fail due to an input error.

By enabling the wireless LAN interface of the PC, the PC may be reconnected to an unintended network. For example, the user may connect a mobile router and the PC by a wireless LAN when he/she goes out, and may connect, in an office, the PC to a desktop AP installed in a company by a wired LAN cable. At this time, in a case where communication of the mobile router is used with a charging system according to an amount of packets, the user may turn off the wireless LAN function when performing wired LAN connection. Therefore, if the wireless LAN function is enabled to perform reconnection to the mobile router in the wireless setup processing of the printer, packets may be consumed against the intention of the user. Furthermore, if the PC is a mobile PC, the PC is reconnected to an intended network, and connection to the printer is switched, thereby unintentionally consuming a battery. As described above, there is the problem that when the wireless LAN interface of the PC is enabled to perform reconnection to an unintended network, convenience of wireless setup processing degrades.

To solve this problem, in the embodiment, restriction processing of restricting reconnection to a wireless LAN in wireless setup processing is executed, thereby enabling the wireless LAN interface without performing reconnection to an unintended network. Thus, the PC can establish wireless connection such as temporary wireless connection to the printer in the wireless setting mode, and can readily perform wireless setup processing of transmitting a wireless setting instruction to the printer. A configuration example for implementing the embodiment will be described in detail below.

### <System Configuration>

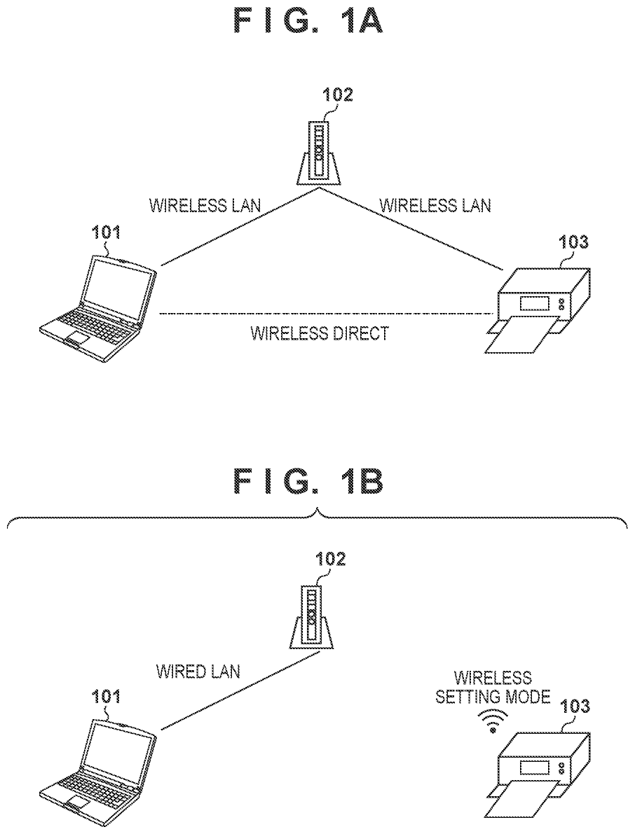

FIGS. 1A and 1B are views each showing an example of the configuration of a communication system according to the embodiment. FIG. 1A shows a state in which a PC 101 and an AP 102 establish infrastructure connection via a wireless LAN. Furthermore, a printer 103 is connected to the AP 102. That is, the PC 101 can communicate with the printer 103 via the AP 102, and establishes wireless infrastructure connection to the printer 103. In infrastructure connection, it is possible to create a network environment where the PC can mutually communicate with a plurality of devices. Note that the example shown in FIG. 1A shows a state in which the printer 103 and the AP 102 establish infrastructure connection via a wireless LAN and the PC 101 and the AP 102 establish infrastructure connection via a wireless LAN. However, the PC 101 and the printer 103 need only be communicable via the AP 102, and the PC 101 may be connected to the AP 102 by a wired LAN.

On the other hand, there is also a connection method called wireless direct connection in which only two devices can communicate with each other. The PC 101 and the printer 103 can perform peer-to-peer connection (to be referred to as P2P connection hereinafter) by wireless direct connection. However, during wireless direction connection, both the PC 101 and the printer 103 use the wireless LAN interface (to be described later) by wireless direct connection, and thus cannot communicate with other devices via the wireless LAN interface. Therefore, wireless direct connection is often used as temporary connection. In this embodiment, the PC 101 performs P2P wireless setting processing of instructing, via wireless connection such as wireless direct connection, the printer 103 to perform connection to the AP 102. Thus, the PC 101 transmits, to the printer 103, using wireless direct connection, connection information for connection to a wireless network. In this embodiment, a method in which the PC 101 transmits, to the printer 103, using wireless direct connection, information (connection information) used for connection to a wireless network is defined as “wireless setting processing”. In addition, a state in which the printer 103 accepts the above-described wireless setting processing is defined as “wireless setting mode”. In other words, in the wireless setting mode, the printer 103 waits for wireless direct connection. Note that FIG. 1B will be described later.

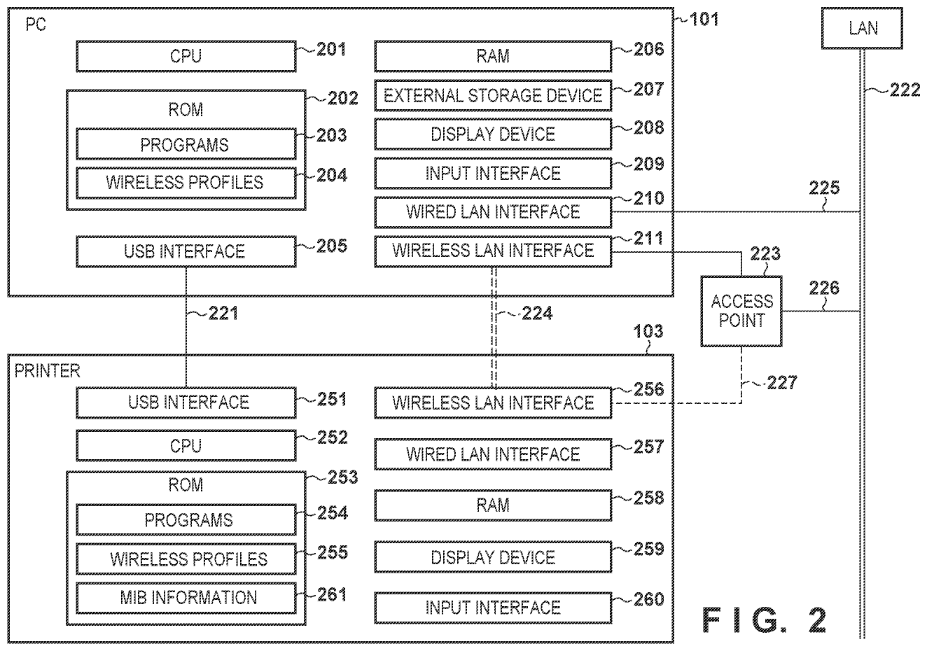

FIG. 2 is a block diagram showing the configuration of the communication system including the hardware arrangements of the PC 101 and the printer 103 according to this embodiment. The PC 101 includes a Central Processing Unit (CPU) 201, a Read Only Memory (ROM) 202, a Random Access Memory (RAM) 206, an external storage device 207, a display device 208, and an input interface (IF) 209. The PC 101 also includes a Universal Serial Bus (USB) IF 205, a wired LAN IF 210, and a wireless LAN IF 211. However, the PC 101 need not include the USB IF 205 or the wired LAN IF 210.

The CPU 201 includes one or more processors, and causes them to execute various processes including the above-described instruction processing by deploying programs 203 stored in the ROM 202 on the RAM 206 and executing them. The ROM 202 stores the programs 203 corresponding to the various processes including the program of the wireless setting processing, and information used by the programs 203, such as wireless profiles 204 (to be described later). The external storage device 207 stores an Operating System (OS), a printer driver, and other various kinds of data. The display device 208 displays a screen in accordance with control of the OS and the programs 203. The input IF 209 accepts a user input, and allows the user to input various kinds of data and instruct an operation. The input IF 209 may include a keypad and buttons. In an example, the display device 208 and the input IF 209 may integrally be formed, like a touch panel display. The wired LAN IF 210 is a wired communication interface for performing communication complying with a wired communication standard such as Ethernet. The wireless LAN IF 211 is a wireless communication interface for performing communication complying with a wireless communication standard such as the IEEE802.11 standard.

The PC 101 can perform P2P communication with the printer 103 via a USB cable 221 connected to the USB IF 205 or via wireless direct connection 224 established by the wireless LAN IF 211. The PC 101 can also be connected to a LAN 222 via a wired LAN cable 225 connected to the wired LAN IF 210. In this case, if the printer 103 can also be connected to the same LAN 222 as the LAN of the PC 101, the PC 101 and the printer 103 can mutually communicate with each other on the same LAN 222. Furthermore, when the PC 101 is connected to an AP 223 by the wireless LAN interface (IF) 211 and the AP 223 is connected to the LAN 222 via a wired LAN cable 226, the PC 101 can be connected to the LAN 222. In addition, if the printer 103 can also be connected to the AP 223, the PC 101 and the printer 103 can mutually communicate with each other via the AP 223.

In this example, the wireless profile 204 is information that includes one or more pieces of connection information each including specification information (an SSID or the like) of the AP 223 connected by the wireless LAN IF 211 and authentication information (a password or the like) used for authentication processing, and usable to establish wireless connection to the AP 223. Note that if a wireless network can be connected without authentication information, the connection information may include only the specification information. The wireless profiles 204 are stored and managed by the OS executed by the CPU 201. The OS is stored in a storage device such as the external storage device 207, and read out and executed by the CPU 201. At this time, the OS stores and manages, as additional information of the wireless profile 204, the priority level of the AP 223 to be connected and a setting of controlling automatic connection. In this embodiment, the setting of controlling automatic connection is included in the wireless profile 204 as a flag associated with the connection information. In this case, the PC 101 can determine, for each SSID designated in the connection information, based on the flag, whether to automatically attempt to establish connection. In another example, the setting of controlling automatic connection can be set as a flag in all the pieces of connection information. In this case, if the flag is set to automatically attempt to establish connection, the PC 101 automatically attempts to establish connection in a predetermined order. On the other hand, if the flag is set not to automatically attempt to establish connection, the PC 101 does not automatically attempt to establish connection using the connection information.

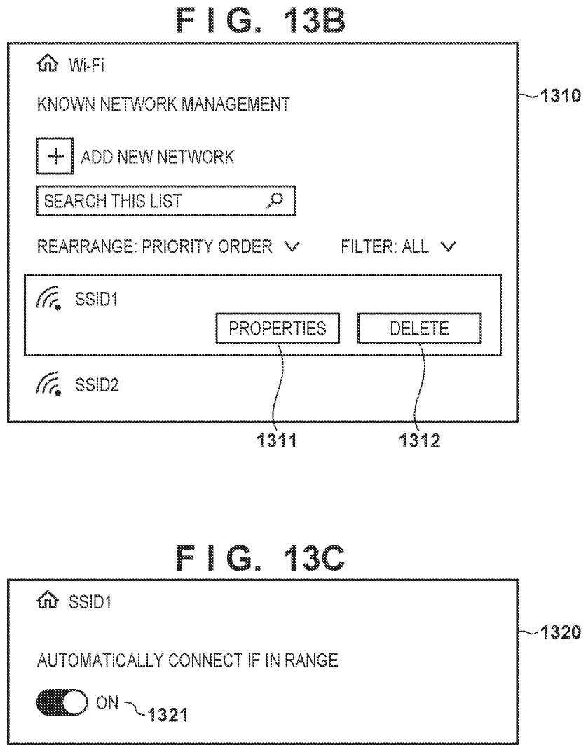

FIG. 13A shows a list screen 1300 of the wireless profiles 204 displayed by the OS. The list screen 1300 is displayed when the user operates the setting screen of the OS. The list screen 1300 displays service set identifiers (SSIDs) of the wireless profiles 204 in accordance with the priority levels of the wireless profiles 204 managed by the OS. In FIG. 13A, since a wireless network 1301 having an SSID “SSID1” has a connection priority level higher than that of a wireless network 1302 having an SSID “SSID2”, the wireless network 1301 is displayed at an upper position. On the list screen 1300, if the user selects one of the wireless profiles of the wireless networks, an operation screen 1310 shown in FIG. 13B is displayed. When the user presses a “delete” button 1312 on the operation screen 1310, the OS can delete the information of the wireless profile. Alternatively, when the user presses a “property” button 1311 on the operation screen 1310, the OS displays the additional information of the wireless profile 204. FIG. 13C shows an additional information display screen 1320 of the wireless profile 204 displayed by the OS. The additional information display screen 1320 includes a setting UI 1321 for controlling the automatic connection setting of the wireless profile 204. When the user sets the automatic connection setting to ON by the setting UI 1321, the OS enables an automatic attempt to establish connection in the wireless profile 204. Alternatively, when the user sets the automatic connection setting to OFF by the setting UI 1321, the OS disables an automatic attempt to establish connection in the wireless profile 204. If reconnection to a network is required, the OS attempts reconnection to an appropriate network based on the additional information of the wireless profile 204. For example, if a plurality of wireless profiles 204 are saved, the OS performs reconnection to a network in accordance with the connection priority levels of the wireless profiles 204. At this time, if automatic connection in the wireless profile 204 is enabled, the OS automatically attempts reconnection to the network in a predetermined order based on the information of the wireless profile 204. On the other hand, if automatic connection in the wireless profile 204 is disabled, the OS does not perform reconnection to a predetermined wireless network unless the user selects the network at an arbitrary timing and performs an operation of reconnecting the wireless LAN IF 211 to the network.

The printer 103 includes a CPU 252, a ROM 253, a RAM 258, a display device 259, an input IF 260, a USB IF 251, a wireless LAN IF 256, and a wired LAN IF 257. The CPU 252 executes various control operations by the printer 103 by reading out programs 254 from the ROM 253 into the RAM 258 and executing them. The ROM 253 stores the programs 254, wireless profiles 255, and Management Information Base (MIB) information 261. Furthermore, the display device 259 displays a screen held by the program 254, thereby presenting the status of the processing and a data input acceptance state to the user. The input IF 260 accepts a user input, and allows the user to input data to the program 254 and instruct an operation. The USB IF 251, the wireless LAN IF 256, and the wired LAN IF 257 are the same as the USB IF 205, the wireless LAN IF 211, and the wired LAN IF 210, respectively, and a description thereof will be omitted. Note that the printer 103 need not include the USB IF 251 or the wired LAN IF 257.

The printer 103 can perform P2P communication with the PC 101 via the USB cable 221 connected to the USB IF 251 or via the wireless direct connection 224 established by the wireless LAN IF 256. Furthermore, the printer 103 can be connected to the LAN 222 via a wired LAN cable 227 connected to the wired LAN IF 257. If the PC 101 is also connected to the LAN 222, the PC 101 and the printer 103 can mutually communicate with each other on the same LAN 222. If the printer 103 is connected to AP 223 by the wireless LAN IF 256, and the AP 223 is connected to the LAN 222 via the wired LAN cable 226, the printer 103 can be connected to the LAN 222. The wireless profile 255 is information including one or more sets of the authentication information (password or the like) and the specification information (SSID or the like) of the AP 223 connected by the wireless LAN IF 256. The wireless profile 255 is stored and managed when the CPU 252 executes the program 254 stored in the ROM 253. For example, when the printer 103 is powered on, the printer 103 can be reconnected, using the wireless profile 255, to the wireless network to which the printer 103 was connected in the past and which is included in the wireless profile 255. For example, the printer 103 may be configured to manage specification information and authentication information with respect to a plurality of wireless networks, similar to the OS of the PC 101. The MIB information 261 is a standard for managing network devices, as described above, and holds information usable by Simple Network Management Protocol (SNMP) for network management. MIB is defined in a tree structure, and each piece of information is linked with a unique Object Identifier (OID). Then, by designating the OID when requesting data using SNMP, it is possible to acquire necessary information.

The ROM 253 also stores a unique SSID uniquely set in the printer 103. The unique SSID is uniquely set for the manufacturer of the printer or a printer model, and the wireless LAN IF 256 of the printer 103 can operate as an AP corresponding to the unique SSID. Therefore, similar to a case where the PC 101 is connected to the AP 223, the PC 101 can directly be connected to the printer 103 that operates as an AP.

Note that processing sharing between the PC 101 and the printer 103 has been described above with reference to FIG. 2, as an example. However, another form may be adopted.

### First Embodiment

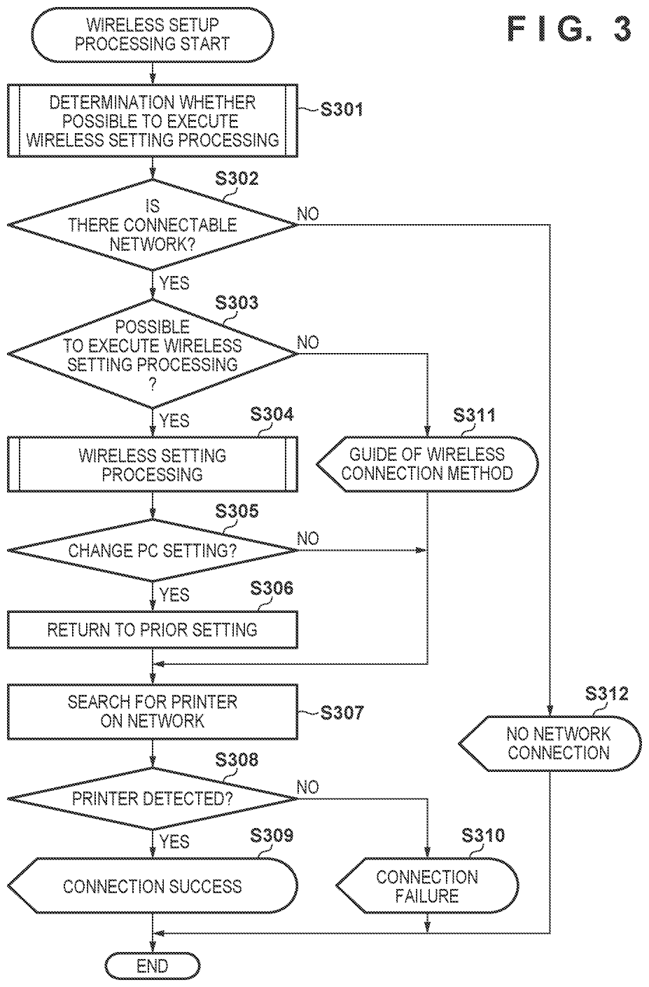

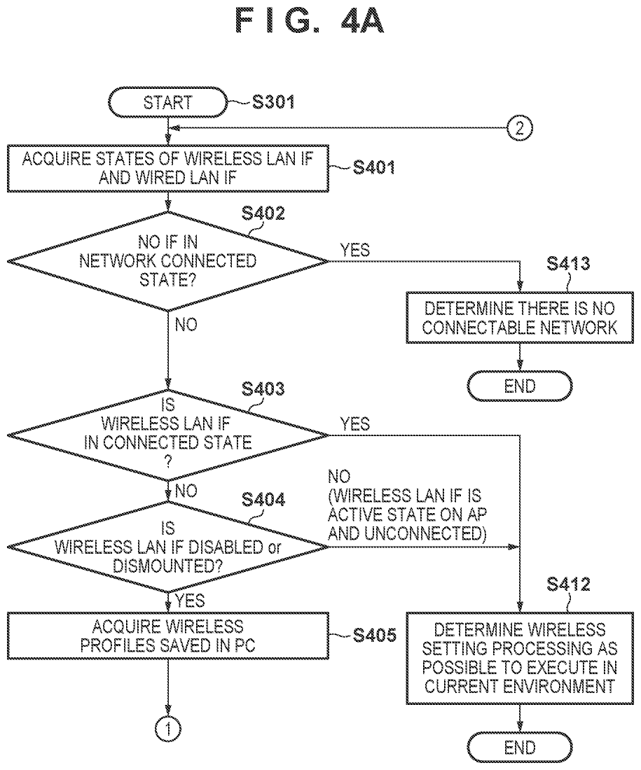

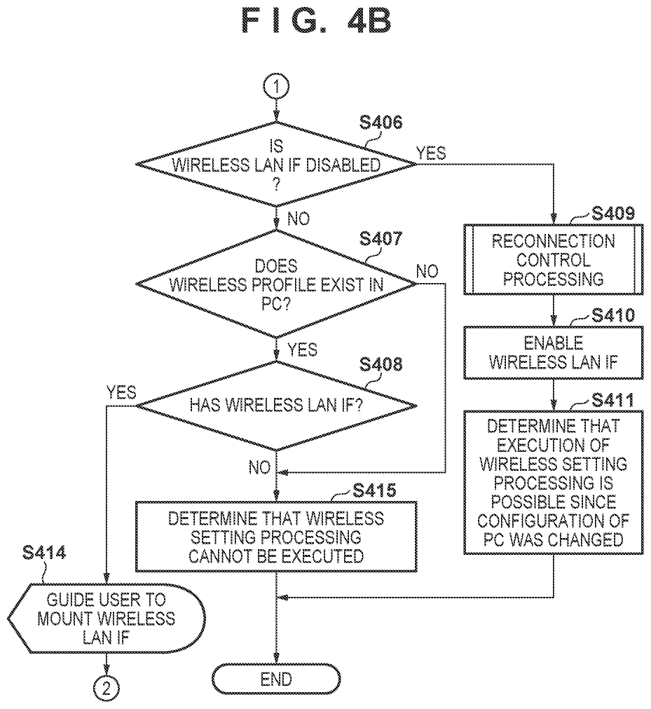

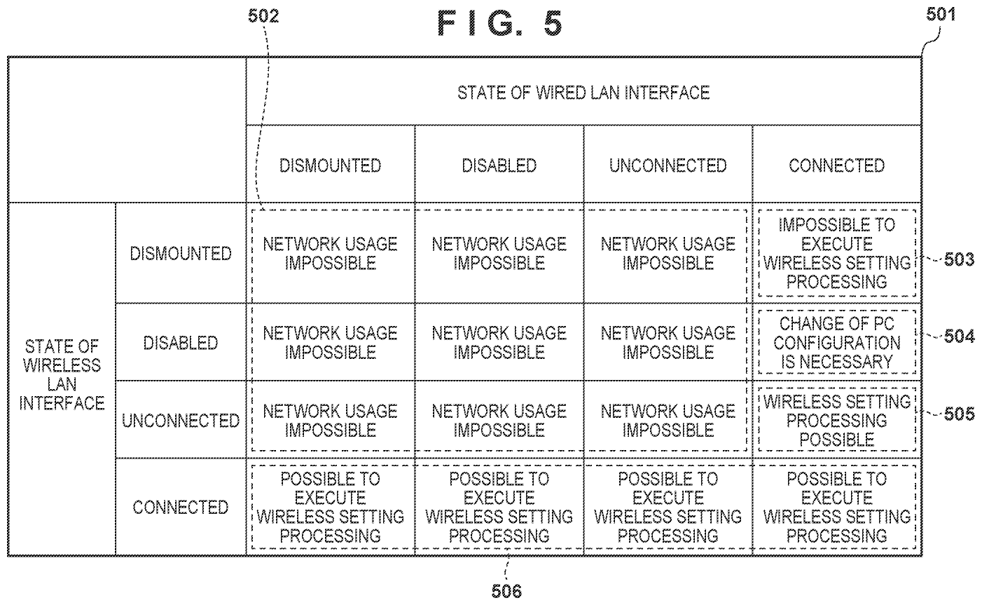

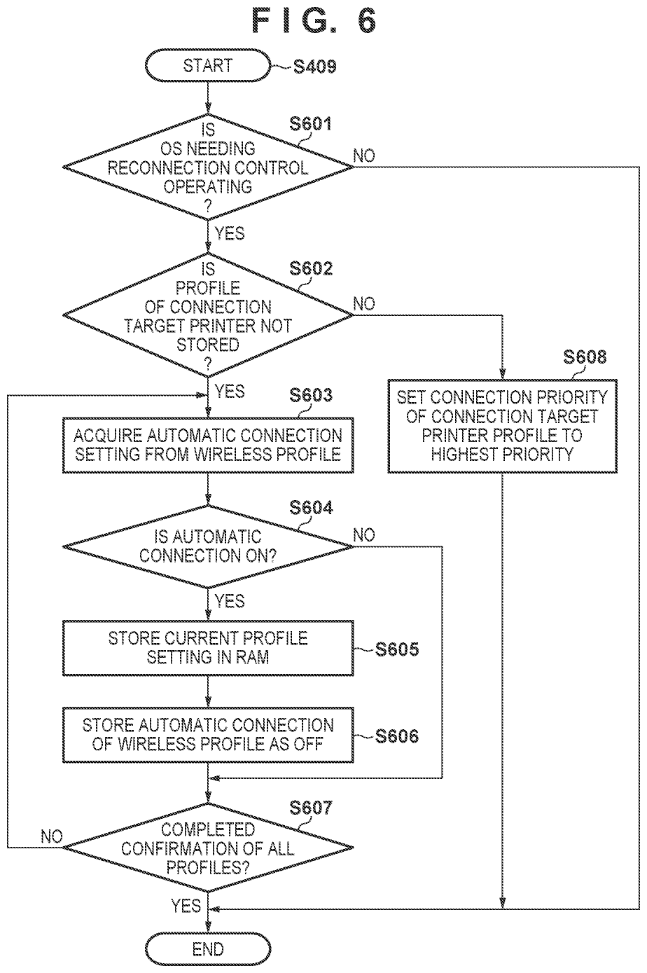

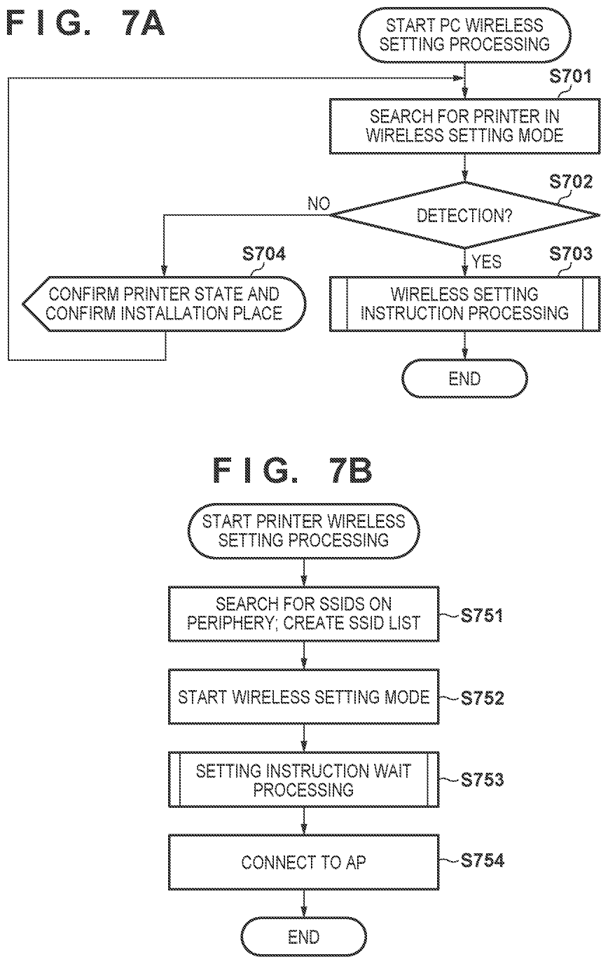

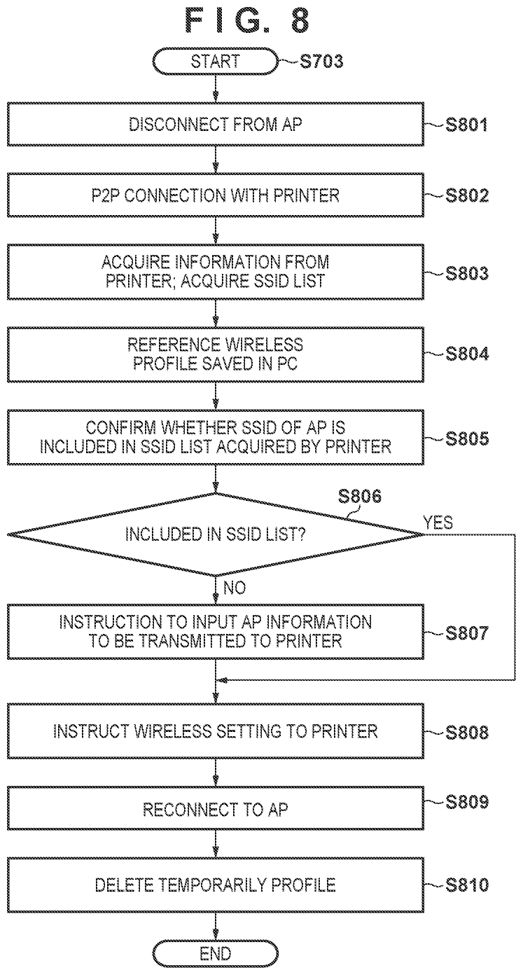

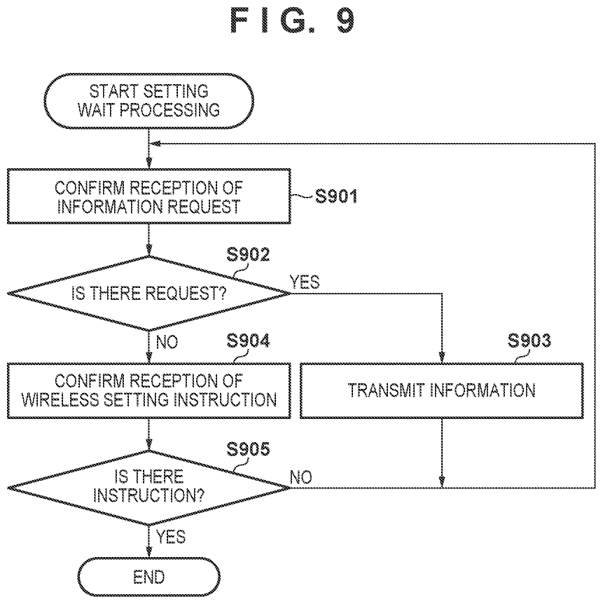

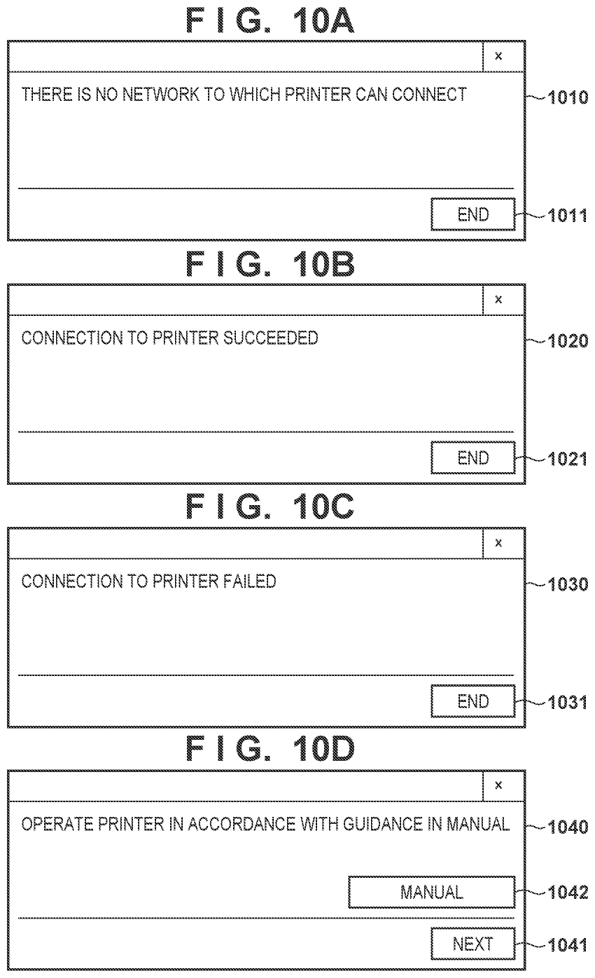

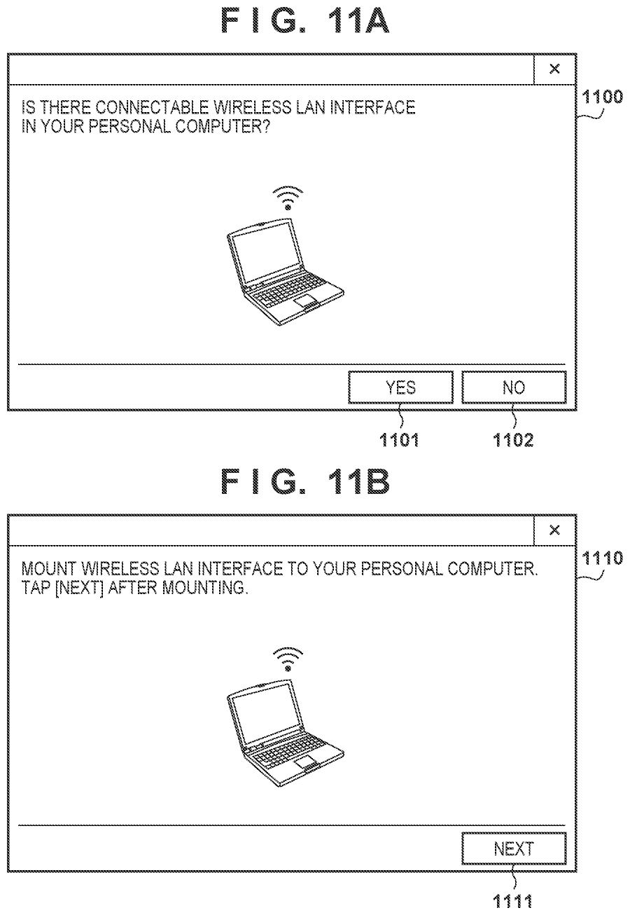

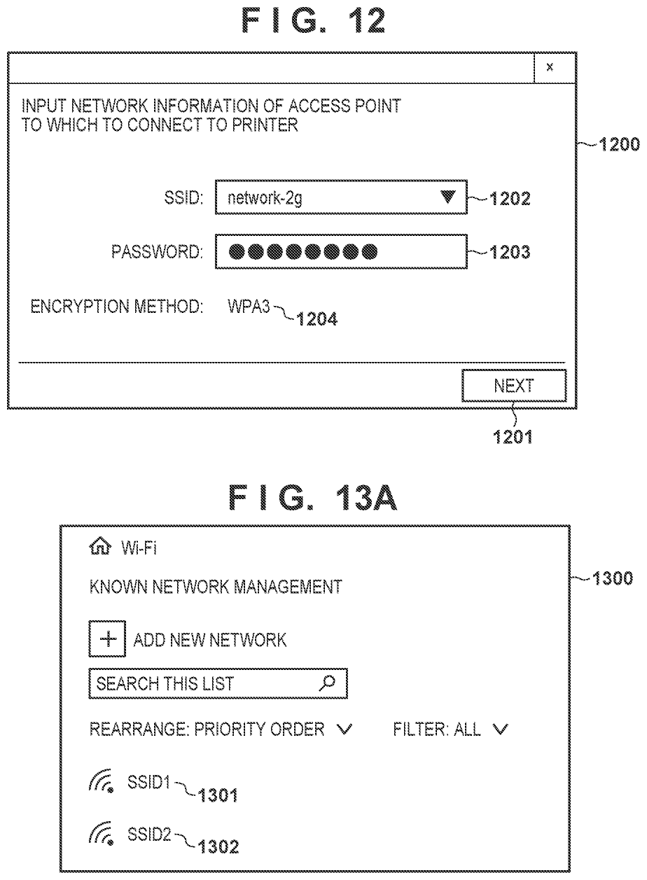

The first embodiment will be described in detail below with reference to FIGS. 3 to 12. FIG. 3 is a flowchart illustrating wireless setup processing in which a PC 101 connects a printer 103 to a network formed by an AP 102 according to the embodiment. Processing by the PC 101 is implemented when a CPU 201 executes a program 203. Similarly, processing by the printer 103 is implemented when a CPU 252 executes a program 254. FIGS. 4A and 4B are flowcharts illustrating processing of determining whether it is possible to execute wireless setting processing, which is executed in step S302 of FIG. 3. Similarly, FIG. 5 is a table showing the determination result of the determination processing shown in FIGS. 4A and 4B based on the states of a wired LAN IF and a wireless LAN IF. Similarly, FIG. 6 is a flowchart illustrating processing of “reconnection control processing” executed in step S409 of FIG. 4B. Similarly, FIGS. 7A and 7B are flowcharts each illustrating processing of “wmireless setting processing” executed in step S304 of FIG. 3. Similarly, FIG. 8 is a flowchart illustrating “wireless setting instruction processing” executed in step S703 of FIG. 7A. Similarly, FIG. 9 is a flowchart illustrating processing of “setting wait processing” executed in step S753 of FIG. 7B. Similarly, FIGS. 10A to 10D are views each showing a screen displayed on a display device 208 of the PC 101 in the processing shown in FIG. 3. Similarly, FIG. 11 shows a screen displayed on the display device 208 of the PC 101 in the determination processing shown in FIG. 5. Finally, FIG. 12 shows a screen displayed on the display device 208 of the PC 101 in the wireless setting instruction processing shown in FIG. 8.

The wireless setup processing of connecting the printer 103 to the AP 102, which is executed by the PC 101, according to this embodiment will be described with reference to FIG. 3. If the PC 101 is currently connected to a network, the PC 101 connects the printer 103 to the same network. When the PC 101 executes a network setting processing application program (to be referred to as a setting application hereinafter) included in the programs 203, the PC 101 starts the wireless setup processing of the printer 103 shown in FIG. 3. Note that the setting application may be able to execute not only network setting processing but also another processing. More specifically, for example, the PC 101 may be able to execute processing of acquiring capability information from the printer 103 as the target of the network setting processing, and processing of transmitting a print job to cause the printer 103 as the target of the network setting processing to execute printing. Note that communication between the PC 101 and the printer 103 by the setting application in the above-described processing can be executed via the network between the PC 101 and the printer 103, which has been set/established by the network setting processing. Note that in this example, the PC 101 has already been connected to the external AP 102, and the printer 103 is in the wireless setting mode. FIG. 1B shows a system configuration at this time.

The PC 101 executes execution enabled/disabled determination processing of determining, based on the connection states of a wireless LAN IF 211 and a wired LAN IF 210, whether it is possible to execute wireless setting processing via P2P connection (step S301). Details of step S301 will be described later with reference to FIG. 5.

If it is determined that there is no connectable network for the wireless setup processing of the printer 103 (NO in step S302), the PC 101 displays, on the display device 208, an non-detection screen 1010 indicating that a network is not detected, as shown in FIG. 10A (step S312). On the non-detection screen 1010, the PC 101 waits until the user selects an “end” button 1011. When the user presses the “end” button 1011, the PC 101 ends the wireless setting processing of the printer shown in FIG. 3.

If it is determined that there is an enable network for the wireless setting processing of the printer 103 in step S301 (YES in step S302), the PC 101 confirms whether it is possible to execute the wireless setting processing (step S303).

If it is determined, based on the result in step S301, that it is possible to execute the wireless setting processing (YES in step S303), the PC 101 executes the wireless setting processing of the printer 103 (step S304). Details of the wireless setting processing will be described later with reference to FIG. 6.

If the setting of the PC 101 has been changed in step S301 (YES in step S305), the PC 101 restores, based on the setting (to be described later) temporarily saved in a RAM 206, the setting of the PC 101 to a state before the processing in step S301 is executed (step S306). If the setting of the PC 101 has not been changed in step S301 (NO in step S305), the PC 101 advances the process to step S307.

The PC 101 searches for a printer on the network (step S307). If a printer 103 that has undergone the wireless setting processing is detected (YES in step S308), the PC 101 considers that the wireless setting processing has succeeded. For example, the PC 101 stores the Media Access Control (MAC) address of a wireless LAN IF 256 of the printer 103 in the wireless setting processing at the time of wireless direct connection. After that, after performing connection to the AP 102 in step S809, an Address Resolution Protocol (ARP) packet is sent. If the MAC address of the printer 103 can be detected in response to the ARP packet, it can be determined that the wireless setup processing of the printer 103 has succeeded. Note that the present invention is not limited to the MAC address and any identifier for uniquely specifying the printer 103 may be used. For example, if the serial number of the printer 103 can be detected, the same determination processing may be performed. At this time, a connection success screen 1020 indicating success of connection is displayed on the display device 208, as shown in FIG. 10B (step S309). The connection success screen 1020 is an example of a screen for notifying the user that connection to the printer 103 via infrastructure connection has succeeded. On the connection success screen 1020, the PC 101 waits until the user selects an “end” button 1021. When the user presses the “end” button 1021, the PC 101 ends the wireless setting processing of the printer 103 shown in FIG. 3.

If a printer 103 that has undergone the wireless setting processing is not detected (NO in step S308), the PC 101 considers that the wireless setting processing has failed. At this time, a connection failure screen 1030 shown in FIG. 10C is displayed on the display device 208 (step S310). The connection failure screen 1030 is an example of a screen for notifying the user that connection to the printer 103 via infrastructure connection has failed and the wireless setting processing has failed. On the connection failure screen 1030, the PC 101 waits until the user selects an “end” button 1031. When the user presses the “end” button 1031, the PC 101 ends the wireless setting processing of the printer 103 shown in FIG. 3. Note that in an example, after the connection failure screen 1030 is displayed in step S310, the printer search processing in step S307 may be re-executed, or the processes from step S301 may be re-executed.

Note that if it is determined, based on the result in step S301, that it is impossible to execute the wireless setting processing (NO in step S303), the PC 101 guides the user concerning an operation method of connecting the printer 103 and the AP 102. At this time, a guide screen 1040 shown in FIG. 10D is displayed on the display device 208 (step S311). On the guide screen 1040, a “manual” button 1042 is arranged. When the user selects the “manual” button 1042, an operation method of the printer 103 and the AP 102 is displayed by a Web browser or the like. Note that display by the pressing of the “manual” button 1042 has been exemplified but the present invention is not limited to this. For example, the PC 101 may activate a Web browser while displaying the guide screen 1040, and present the content to the user. Alternatively, the content may be embedded and displayed on the guide screen 1040. Alternatively, on the guide screen 1040, a message corresponding to the content may be displayed. The guide screen 1040 waits until the user presses a “next” button 1041 after guiding the user concerning the method of connecting the printer 103 to the AP 102. When the user presses the “next” button 1041 in accordance with the guide on the guide screen 1040, the PC 101 executes printer search processing on the network (step S307). The subsequent processes in steps S308 to S310 are the same as those described above.

The execution enabled/disabled determination processing (step S301 of FIG. 3) of the wireless setting processing executed by the PC 101 according to this embodiment will be described with reference to FIGS. 4A and 4B.

When the execution enabled/disabled determination processing is started, the PC 101 acquires the states of the wireless LAN IF 211 and the wired LAN IF 210 (to be sometimes referred to as “IFs” without discrimination hereinafter) (step S401). More specifically, the PC 101 acquires information concerning whether the IFs are mounted and information of networks currently connected to the various IFs by executing the Application Programming Interface (API) of the OS. The PC 101 classifies the IF into four states based on the acquired detection result of the IF. As the first state, the PC 101 determines that the IF is in a “dismounted” state in a case where the PC 101 does not include the IF. For example, in a desktop PC including no wireless LAN IF, the PC 101 determines the “dismounted” state of the wireless LAN IF. As the second state, the PC 101 determines that the IF is in a “disabled” state in a case where the IF is disabled. For example, in a case where the wireless LAN IF 211 is mounted but a setting of establishing no connection via the wireless LAN IF 211 is set (OFF) by the setting of the OS, the PC 101 determines that the wireless LAN IF 211 is in the “disabled” state. As the third state, in a case where the IF is enabled but the PC 101 is not connected to a network, the PC 101 determines that the IF is in an “unconnected” state. As the fourth state, in a case where the IF is enabled and the PC 101 is connected to a network, the PC 101 determines that the IF is in a “connected” state. For example, if the wireless LAN IF is in the enable state but the PC 101 is not connected to the AP 102, the PC 101 determines that the wireless LAN IF is in the “unconnected” state. Alternatively, in a case where the wireless LAN IF 211 is in the enable state and the PC 101 is connected to the AP 102 via the wireless LAN IF 211, the PC 101 determines that the wireless LAN IF 211 is in the “connected” state. More specifically, in a case where packet transmission/reception to/from the Internet Protocol address (IP address) of the default gateway of the IF can normally be performed, the PC 101 determines a state in which the IF is connected to the network.

Based on the acquired state of the IF, the PC 101 decides whether it is possible to execute the wireless setting processing (steps S402 to S404 and S406).

Combinations that can be obtained based on the states of the IFs will be described with reference to FIG. 5. A table 501 shown in FIG. 5 shows a result that can be decided by the PC 101 based on a combination of the four states for the types of the IFs. In the following description, combinations of the states of the IFs when it is decided whether it is possible to execute the wireless setting processing (steps S402 to S404 and S406) will be described with reference to FIG. 5.

If both the wired LAN IF and the wireless LAN IF are not in the “connected” state (YES in step S402), the PC 101 decides that there is no network that can be set in the printer 103 by the PC 101 and it is impossible to execute the wireless setting processing (step S413), thereby ending the processing of FIGS. 4A and 4B. In FIG. 5, 502 indicates combinations when it is determined that there is no network that can be set in the printer 103 by the PC 101.

On the other hand, if one of the IFs is in the “connected” state (NO in step S402), there is a network that can be set in the printer by the PC 101, and thus the PC 101 decides to execute the wireless setting processing, and advances the process to step S403.

If the wireless LAN IF is in the “connected” state (YES in step S403), the PC 101 decides to execute the wireless setting processing with the current configuration (step S412), thereby ending the processing shown in FIGS. 4A and 4B. In FIG. 5, 506 indicates combinations when it is determined that the PC 101 can execute the wireless setting processing with the current configuration.

On the other hand, if the wireless LAN IF is not in the “connected” state (NO in step S403), the PC 101 advances the process to step S404. The case where the wireless LAN IF is not in the “connected” state (NO in step S403) corresponds to a case where the wired LAN IF is in the “connected” state. That is, the determination processing in step S403 is processing of determining whether the wireless LAN IF is in the “connected” state, and processing of determining whether the wired LAN IF is not in the “connected” state. That is, if the state corresponds to one of 503 to 505 in FIG. 5, the PC 101 executes processes from step S404.

If the wireless LAN IF is not in either the “disabled” state or the “dismounted” state (NO in step S404), the PC 101 determines that it is possible to execute the wireless setting processing with the current configuration (step S412), thereby ending the processing shown in FIGS. 4A and 4B. In FIG. 5, 505 indicates a combination when it is determined that the PC 101 can execute the wireless setting processing with the current configuration.

On the other hand, if the wireless LAN IF is in the “disabled” state or the “dismounted” state (YES in step S404), the PC 101 acquires all the wireless profiles 204 saved in the ROM 202 (step S405). More specifically, the PC 101 acquires the wireless profiles 204 saved in the ROM 202 by executing the API of the OS. Alternatively, without executing the API, the PC 101 acquires, by the OS, a list of the wireless profiles 204 from a registry or a folder in which the wireless profiles 204 are saved.

If the wireless LAN IF is in the “dismounted” state (NO in step S406), and there exists at least one acquired wireless profile (YES in step S407), the PC 101 determines that the wireless LAN IF was mounted in the PC 101 in the past. That is, the user may have a device that adds a wireless LAN IF to the PC 101, such as a retrofit device. Therefore, the PC 101 confirms with the user whether the user has a wireless LAN IF (step S408).

At this time, a confirmation screen 1100 for confirming whether the user has a wireless LAN IF is displayed on the display device 208, as shown in FIG. 11A. On the confirmation screen 1100, a “YES” button 1101 used to agree with the confirmation message of the screen and a “NO” button 1102 used not to agree with the confirmation message of the screen are provided. The confirmation screen 1100 prompts the user to press the “YES” button 1101 or the “NO” button 1102 in accordance with whether the user has a wireless LAN IF. For example, if the user has no wireless LAN interface, the user presses the “NO” button 1102, and the PC 101 determines that the user has no wireless LAN IF (NO in step S408), and advances the process to step S415. In step S415, the PC 101 determines that it is impossible to execute the wireless setting processing, thereby ending the processing shown in FIGS. 4A and 4B. In FIG. 5, 503 indicates a combination when it is determined that the PC 101 cannot execute the wireless setting processing with the current configuration.

On the other hand, if the user has a wireless LAN IF, the user presses the “YES” button 1101, and the PC 101 determines that the user has a wireless LAN IF (YES in step S408). In this case, the PC 101 notifies the user to connect the wireless LAN IF to the PC 101 (step S414).

At this time, the PC 101 displays a mount instruction screen 1110 shown in FIG. 11B on the display device 208. On the mount instruction screen 1110, a “next” button 1111 is arranged. The mount instruction screen 1110 prompts the user to press the “next” button 1111 after guiding an instruction to mount the wireless LAN interface on the PC 101. If the user presses the “next” button 1111 in accordance with the guide on the mount instruction screen 1110, the PC 101 acquires the states of various IFs again (step S401). After that, the PC 101 advances the process based on the acquired states of the various IFs. On the other hand, if there is no acquired wireless profile (NO in step S407), the PC 101 determines that the PC did not use the wireless LAN IF in the past. In this case, since the PC 101 has no wireless profile to be transmitted, the PC 101 determines that it is impossible to execute the wireless setting processing with the current configuration (step S415), thereby ending the processing shown in FIGS. 4A and 4B. In FIG. 5, 503 indicates a combination when it is determined that it is impossible to execute the wireless setting processing.

On the other hand, if the PC 101 determines that the wireless LAN IF is in the “disabled” state (YES in step S406), the PC 101 determines that it is possible to execute the wireless setting processing by setting the wireless LAN IF 211 in the enable state. However, by setting the wireless LAN IF in the enable state, the PC 101 may automatically be connected, by the OS, to a network to which the PC 101 was connected before. That is, the PC 101 may be connected, by the OS, to one or more networks via the wired LAN IF and the wireless LAN IF. At this time, the PC 101 may be reconnected to a network from which the user intentionally disconnects the PC, the PC 101 may set a wireless profile that should not be set in the printer 103, and thus connection processing may fail. To cope with this, the PC 101 executes reconnection control processing of controlling reconnection of the wireless LAN IF before enabling the wireless LAN IF (step S409). Note that since the processing in step S409 is processing executed when NO is determined in step S403, the processing in step S409 is processing executed when the wireless LAN IF is in the “connected” state.

The reconnection control processing will be described with reference to FIG. 6. The reconnection control processing shown in FIG. 6 is restriction processing of restricting a communication apparatus to be automatically reconnected when the wireless LAN IF 211 of the PC 101 is enabled. After the start of the reconnection control processing (step S409), the PC 101 determines whether reconnection control is necessary for the OS executed by the PC 101 (step S601). For example, depending on the version of the OS, the OS has a mechanism of controlling not to perform reconnection to the wireless LAN. That is, in a specific version, in a case where the PC is already connected to another network (for example, a network connected by the wired LAN IF) when the wireless LAN IF is enabled, the PC 101 is not automatically connected, by the OS, to the network to which the PC 101 was connected before. In this case, the PC 101 determines that the OS is not an OS for which reconnection control is necessary. That is, more specifically, step S601 is, for example, processing of determining whether the version of the OS of the PC 101 is the specific version. Note that the specific version is, for example, Windows 10, and a version that is not the specific version is Windows 7. If the OS is an OS for which reconnection control is unnecessary (NO in step S601), the PC 101 ends the reconnection control processing shown in FIG. 6. That is, control of setting automatic connection to OFF is not executed. Note that in this embodiment, this determination processing is executed when the wireless LAN IF is in the “connected” state, as described above. That is, in this embodiment, if the wired LAN IF is in the “connected” state and the version of the OS of the PC 101 is the specific version, control of setting automatic connection to OFF is not executed. However, even if the version of the OS of the PC 101 is the specific version, if the wired LAN IF is not in the “connected” state, the PC 101 may automatically be connected, by the OS, to the network to which the PC was connected before. Therefore, in a case where the wired LAN IF is not in the “connected” state, control of setting automatic connection to OFF may be executed regardless of the version of the OS of the PC 101. Note that since whether the OS is an OS for which reconnection control is necessary depends on the specifications of the OS, the PC 101 may execute the reconnection control processing from step S602 regardless of the version of the OS. That is, in the reconnection control processing, the processing (step S601) of determining whether the OS of the PC 101 is an OS for which reconnection control is necessary may be omitted. That is, even if the wired LAN IF is in the “connected” state, and the PC 101 has any OS, the processes from step S602 may be executed.

If the OS is an OS for which reconnection control is necessary (YES in step S601), the PC 101 determines whether the wireless profiles acquired in step S405 include the wireless profile 204 for establishing P2P connection to the connection target printer 103 (step S602). For example, if the wireless profiles include a character string associated with the model name of the connection target printer, the PC 101 determines that the wireless profile for connection to the connection target printer 103 is included. Alternatively, if the wireless profiles include a character string determined in advance with the printer, the PC 101 determines that the wireless profile for connection to the connection target printer 103 is included. When performing the wireless setting processing, the PC 101 performs P2P connection to the printer 103 by wireless direct connection. At this time, the wireless profile 204 of the printer 103 can be saved in the ROM 202 by the OS in association with a connection priority level. In this situation, even if the PC 101 is automatically reconnected to the printer 103 in the wireless setting processing, user convenience does not degrade. Therefore, if the wireless profile 204 concerning the connection target printer 103 is included (NO in step S602), the PC 101 changes the connection priority level of the wireless profile 204 to the highest priority level, and saves it (step S608), thereby ending the processing shown in FIG. 6. That is, the reconnection restriction processing includes processing of making a setting to perform reconnection only to the printer 103 and processing of changing the priority level of an attempt to establish connection to the printer 103. Note that the processing in step S602 may be omitted. That is, the processes from step S603 may be executed regardless of whether the wireless profile 204 for establishing P2P connection to the connection target printer 103 is included.

This allows the PC 101 to be automatically reconnected to the connection target printer 103 when the wireless LAN IF is enabled, in a case where it is possible to perform reconnection to the printer 103. Furthermore, it is possible to avoid a situation in which the PC 101 is reconnected to a device other than the printer 103 although the PC 101 can be connected to the connection target printer 103. Note that depending on the specifications of the wireless setting processing application, the PC 101 can delete the wireless profile 204 of the printer 103 after completion of the wireless setting processing. Therefore, in the reconnection control processing, the PC 101 may omit the processing (step S602) of determining whether the wireless profile 204 concerning the connection target printer 103 is included. In this case, as will be described later, the reconnection destination restriction processing includes processing of making a setting not to automatically attempt to establish connection when the wireless LAN IF 211 of the PC 101 is enabled.

If the wireless profile 204 concerning the connection target printer 103 is not included (YES in step S602), the PC 101 acquires information concerning the automatic connection setting in the wireless profile 204 (step S603). If the automatic connection setting in the acquired wireless profile 204 is “OFF” (NO in step S605), the PC 101 determines that reconnection control is unnecessary. On the other hand, if the automatic connection setting in the acquired wireless profile 204 is “ON” (YES in step S604), the PC 101 considers that reconnection control processing needs to be performed. Therefore, the PC 101 temporarily stores, in the RAM 206, the information indicating that the automatic connection setting in the wireless profile 204 is “ON” (step S605), and changes the automatic connection setting in the wireless profile 204 to “OFF” and saves it (step S606). In step S605, the acquired wireless profile 204 may be stored in the RAM 206, and the automatic connection setting in the wireless profile 204 stored in the ROM 202, that is, the wireless profile 204 referred to by the OS may be changed in step S606. Alternatively, part of information such as the SSID of the wireless profile in which the automatic connection setting is “ON” may be stored in step S605, and the automatic connection setting in the wireless profile 204 in the ROM 202 may be changed in step S606. Furthermore, the setting application need not execute processing of changing the automatic connection setting in the wireless profile 204 to “OFF” and saving it. That is, the setting application may instruct the OS to execute this processing, and the OS may then execute this processing.

As described above, in step S606, the automatic connection setting in the wireless profile 204 not corresponding to the connection target printer 103 is changed to “OFF”. This can avoid automatic connection to a network formed by a communication apparatus different from the connection target printer 103 when the PC 101 enables the wireless LAN IF 211. In step S607, it is possible to obtain the same effect even in a form in which the PC 101 instructs the OS to set the automatic connection setting in the wireless profile 204 to “OFF” by the API of the OS. That is, the reconnection restriction processing includes processing of setting the automatic connection setting to “OFF”.

If another wireless profile 204 exists (NO in step S607), the PC 101 acquires the information of the next wireless profile 204, and confirms the automatic connection setting (steps S603 to S606). If the PC 101 confirms all the wireless profiles 204 (YES in step S607), the PC 101 ends the reconnection control processing shown in FIG. 6.

After performing the wireless LAN reconnection control processing in step S409, the PC 101 enables the wireless LAN IF (step S410). More specifically, the PC 101 switches the state of the wireless LAN IF 211 from the disabled state to the enable state via the API of the OS. Alternatively, the PC 101 may display, on the display device 208, a screen (not shown) for instructing the user to enable the wireless LAN IF 211 in the PC 101.

The PC 101 determines that the wireless setting processing can be executed by enabling the wireless LAN IF 211 (step S411), thereby ending the processing shown in FIGS. 4A and 4B. In FIG. 5, 504 indicates a combination when it is determined that the wireless setting processing can be executed when the PC 101 changes the configuration of the PC.

In this embodiment, with the above processing, the PC 101 can execute the wireless setting processing by switching the wireless LAN IF 211 from the disabled state to the enable state. This allows the user to connect the printer 103 to the network by a simpler method without operating the printer 103 and the AP 102. At this time, by performing reconnection control, the PC 101 can perform control so the wireless LAN IF 211 is not automatically connected to another network. This allows the user to execute the wireless setting processing without performing connection to an unintended network.

The wireless setting processing executed by the PC 101 and the setting wait processing executed by the printer 103 according to this embodiment will now be described with reference to FIGS. 7A and 7B. There is provided a method of instructing, from the PC 101, to execute the wireless setting processing of the printer 103, and the procedure of the processing of the method will be described with reference to FIGS. 7A and 7B. Note that if the PC 101 is connected to the external AP 102, specification information such as the SSID of the AP 102 and authentication information such as a password are stored in the wireless profile 204. Furthermore, if the PC 101 is connected to the external AP 102 via the wired LAN interface, the SSID and password of the AP 102 are not stored in the wireless profile 204. FIG. 1B shows a system configuration in which the PC 101 is connected to the external AP 102 via the wired LAN interface.

FIG. 7A shows the processing executed by the setting application, and the wireless setting processing executed by the PC 101. After the start of the wireless setting processing (step S304), the PC 101 searches for the printer 103 in the wireless setting mode (step S701), and determines, based a search result, whether the printer 103 has been detected (step S702). More specifically, the SSID of a communication apparatus on the periphery is specified based on a beacon detected by the wireless LAN IF 211. If the PC 101 detects an SSID unique to the printer 103, it is determined that the printer 103 has been detected. If it is determined in step S702 that the PC 101 has detected the printer 103 in the wireless setting mode (YES in step S702), the PC 101 starts the wireless setting instruction processing of instructing the printer 103 to execute the wireless setting processing (step S703). On the other hand, if the printer 103 in the wireless setting mode has not been detected (NO in step S702), a screen (not shown) for prompting the user to confirm the state and installation place of the printer 103 is displayed (step S704). For example, the PC 101 displays a screen (not shown) for prompting the user to confirm whether the printer 103 is in the wireless setting mode and whether the printer 103 and the PC 101 are installed close to each other. After that, the PC 101 searches again for the printer 103 in the wireless setting mode (step S701).

The wireless setting instruction processing will now be described with reference to FIG. 8. After the start of the wireless setting instruction processing (step S703), the PC 101 disconnects the wireless connection from the AP 102 (step S801), and then performs wireless direct connection to the printer 103 (step S802). More specifically, the PC 101 connects the wireless LAN IF 211 to the communication apparatus of the unique SSID corresponding to the printer 103. Note that if the PC 101 is connected to the AP 102 via a wire by the wired LAN IF 210, that is, the PC 101 is not wirelessly connected to the AP 102, the PC 101 skips step S801. Next, the PC 101 issues an information acquisition request to the printer 103, and receives an SSID list by obtaining a response to the request from the printer 103 (step S803). The received SSID list indicates APs found by the printer 103.

Next, the PC 101 refers to the wireless profiles 204 (step S804), and acquires the wireless profile 204 including the SSID of the AP 102 which was connected at the start of the wireless setting instruction processing and from which the wireless connection was disconnected in step S801. If there exists the wireless profile, the PC 101 confirms whether the SSID of the AP 102 acquired in step S804 is included in the SSID list obtained in step S803 (step S805). If it is confirmed that the wireless profile exists in the SSID list (YES in step S806), the PC 101 determines to transmit a wireless setting instruction to the printer 103 to perform connection to the AP 102 using the wireless profile. That is, by selecting the wireless profile of the AP 102 which was connected at the start of the wireless setting instruction processing, the user need not select or input wireless profile information (including the SSID and password).

If it cannot be confirmed in step S805 that the SSID of the AP 102 is included in the SSID list (NO in step S806), the PC 101 instructs the user to input the wireless profile information (including the SSID and password) of the AP 102 (step S807). For example, if the PC 101 is connected to the AP 102 by the wired LAN interface, there is no profile, and thus it is determined that the SSID of the AP 102 is not included in the SSID list (NO in step S806). In step S807, the PC 101 displays, on the display device 208, a network information input screen 1200 shown in FIG. 12. The network information input screen 1200 includes a dropdown list 1202 for selecting “SSID name”, an input region 1203 where “password” is input, and an encryption method display region 1204 for displaying the encryption method of the selected SSID. The dropdown list 1202 shows information of the SSID list acquired from the printer 103 in step S803. If the SSID is selected from the dropdown list 1202, the encryption method display region 1204 displays, as additional information concerning the SSID, encryption method information acquired from the printer 103. Note that the selection of the SSID by the dropdown list 1202 has been exemplified but the present invention is not limited to this. For example, instead of the dropdown list 1202, the user may input an arbitrary SSID using a keypad. In this case, the encryption method display region 1204 may be in such form that the user can select an arbitrary encryption method. The password input region 1203 is a region where a password character string for connection to the selected SSID is input. The password is a key used for encryption by the encryption method displayed in the encryption method display region 1204. In the password input region 1203, the input password is replaced by other characters such as ● so the password cannot be seen from the outside, and displayed on the screen for security reasons. In order for the user to confirm the input characters, the network information input screen 1200 may include a UI (not shown) for switching the display to display the password character string according to the input characters. The network information input screen 1200 guides the user to input network information for connecting the printer 103 to the AP 102, and then prompts the user to press a “next” button 1201. If the user presses the “next” button 1201 in accordance with the guide on the network information input screen 1200, the PC 101 holds the input network information as information corresponding to the wireless profile of the AP 102. At this time, the PC 101 may perform processing of verifying whether the input network information is correct. More specifically, the PC 101 may verify whether the input password matches the format of the designated encryption method. If, as a result of the verification, it is determined that a combination of the password and the encryption method is erroneous, the PC 101 displays the network information input screen 1200 again to prompt the user to input correct information.

If the PC 101 confirms that the SSID of the AP 102 is included in the SSID list acquired from the printer 103 (YES in step S806), or the PC 101 acquires the wireless profile information of the AP 102 input by the user (step S807), the PC 101 transmits a wireless setting instruction to the printer 103 (step S808). More specifically, in step S808, the PC 101 transmits the wireless profile information (including the SSID and password) of the AP 102 to the printer 103. Next, the PC 101 disconnects the wireless direct connection from the printer 103, and is reconnected to the AP 102 from which the wireless connection has been disconnected in step S801 (step S809). Since the wireless profile 204 of the AP 102 is saved in the ROM 202 of the PC 101, the PC 101 can be reconnected to the AP 102 in step S809 without requiring the user to reinput the password and the like. On the other hand, if the PC 101 is connected to the AP 102 by the wireless LAN IF 211, the PC 101 skips step S809. Subsequently, if there exists the wireless profile which remains since the P2P connection is temporarily established, the PC 101 deletes the wireless profile (step S810). The processing in step S810 is performed to avoid a state in which the wireless profile of connection unintended by the user remains so as not to perform P2P connection to the printer 103 in processing other than the wireless setting processing. Then, the PC 101 ends the wireless setting instruction processing shown in FIG. 8. Furthermore, in step S810, reset processing of saving again, in the ROM 202, at least part of the wireless profile 204 saved in the RAM 206 and temporarily stored before execution of the wireless setting processing may be executed. Thus, after the wireless setup, if the user enables the wireless LAN IF 211, it is possible to perform automatic connection to the AP 102 or another communication apparatus with the original setting, and to prevent the automatic connection setting from being changed by the wireless setup.

After the end of the wireless setting instruction processing in step S703, the PC 101 ends the wireless setting processing shown in FIG. 7A.

Subsequently, the wireless setting processing of the printer 103 will be described in detail with reference to FIG. 7B. For example, if the user powers on the printer 103 using the input IF 260 of the printer 103, the printer 103 automatically shifts to the wireless setting mode only at the time of initial activation. In another example, if the user operates the printer 103 via the input IF 260 and instructs to execute the wireless setting processing, the printer 103 shifts to the wireless setting mode. The printer 103 set in the wireless setting mode causes the wireless LAN IF 256 to operate as an AP having a unique SSID. In an example, the unique SSID includes a character string corresponding to the model name of the printer 103 or a character string with which the printer 103 can be estimated from the SSID, such as “printer”. The wireless setting mode is a mode in which the PC 101 can be connected to the printer 103 without using the authentication information (the password or the like). Since the printer 103 operates as an AP having a low security level, the wireless setting mode is temporarily used to perform the wireless setting processing of the printer 103. The printer 103 shifts to the wireless setting mode by using, as a trigger, a specific condition such as a timing of power-on at the time of initial activation after the user purchases the printer 103. Note that another method may be used as a trigger for shifting to the wireless setting mode. For example, when the user gives a predetermined instruction using the display device 259 or the input IF 260 of the printer 103, the printer 103 may shift to the wireless setting mode.

The printer 103 searches for SSIDs on the periphery before shifting to the wireless setting mode, and creates an SSID list including the detected SSIDs (step S751). After that, the printer 103 shifts to the wireless setting mode (step S752). Then, the printer 103 executes setting wait processing (step S753).

The setting wait processing will be described with reference to FIG. 9. After the start of the setting wait processing in step S753, the printer 103 first confirms whether an information request has been received from the PC 101 (step S901). If the printer 103 determines in step S902 that the information request has been received from the PC 101 (YES in step S902), the printer 103 performs information transmission processing requested from the PC 101 (step S903), and returns the process to step S901. More specifically, if it is determined in step S902 that the information request has been received from the PC 101, the printer 103 transmits, in step S903, the SSID list created in step S751 to the PC 101. If the printer 103 determines that no information request has been received from the PC 101 (NO in step S902), the printer 103 confirms whether a wireless setting instruction has been received from the PC 101 (step S904). If the printer 103 determines that the wireless setting instruction has been received from the PC 101 (YES in step S905), the printer 103 ends the setting wait processing shown in FIG. 9. On the other hand, if the printer 103 determines that no wireless setting instruction has been received from the PC 101 (NO in step S905), the printer 103 returns the process to step S901. Note that in this embodiment, the printer 103 performs the determination processes in steps S902 and S905 in this order but the present invention is not limited to this, and the printer 103 may perform the determination processes in an arbitrary order.

After the end of the setting wait processing in step S753, the printer 103 executes processing for connection to the AP 102 designated by the PC 101 (step S754). More specifically, the printer 103 executes processing for connection to the AP 102 using the specification information (the SSID or the like) and the authentication information (the password or the like) included in the wireless profile 204 received from the PC 101. Then, the printer 103 ends the wireless setting processing shown in FIG. 7B.

As described above, it is possible to connect the printer 103 and the AP 102 without requiring the user to operate the printer 103, by transmitting, to the printer 103, the wireless profile information of the AP 102 held by the PC 101. At this time, in a state in which the PC 101 is reconnected to another communication apparatus by enabling the wireless LAN IF 211, the PC 101 unwantedly transmits the wireless profile information of the other communication apparatus to the printer 103 based on the determination in step S806. To cope with this, the PC 101 controls not to perform connection to an unintended network before enabling the wireless LAN IF 211. This can prevent the PC 101 from transmitting, to the printer 103, the wireless profile information to be used for connection to the communication apparatus different from the AP 102.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-021869, filed Feb. 15, 2023, which is hereby incorporated by reference herein in its entirety.

What is claimed is:

1. A communication apparatus comprising:
a detection unit configured to detect a state of a wireless communication interface of the communication apparatus;
an enabling unit configured to enable the wireless communication interface by executing restriction processing of restricting establishment of connection via the wireless communication interface in a case where the detection unit detects a state in which the wireless communication interface is disabled;
an establishment unit configured to establish wireless connection to a first another communication apparatus via the enabled wireless communication interface; and
a transmission unit configured to transmit, to the first other communication apparatus, via the wireless connection, connection information usable for connection to a second another communication apparatus different from the first other communication apparatus.

2. The apparatus according to claim 1, wherein the restriction processing includes processing of making a setting so that the establishment unit is automatically connected only to the first other communication apparatus.

3. The apparatus according to claim 2, further comprising a storage unit configured to store at least one piece of connection information usable to establish connection to another communication apparatus to which the communication apparatus was connected in the past,
wherein the establishment unit attempts to perform connection in a predetermined order in accordance with the at least one piece of connection information stored in the storage unit, and
the restriction processing is processing of setting the predetermined order to attempt to perform connection to the first other communication apparatus with highest priority in a case where connection information usable for connection to the first other communication apparatus is included.

4. The apparatus according to claim 2, further comprising a storage unit configured to store at least one piece of connection information usable to establish connection to another communication apparatus to which the communication apparatus was connected in the past and store, in association with the at least one piece of connection information, a flag indicating whether to automatically attempt to establish connection,
wherein the establishment unit automatically attempts to perform connection to another communication apparatus in accordance with the flag stored in the storage unit, and
the restriction processing is processing of setting the flag stored in the storage unit not to perform connection to another communication apparatus different from the first other communication apparatus.

5. The apparatus according to claim 4, wherein
the enabling unit temporarily stores the flag stored in the storage unit, and
the enabling unit executes reset processing of returning the flag stored in the storage unit by the temporarily stored flag after the transmission unit transmits the connection information.

6. The apparatus according to claim 1, wherein the restriction processing is processing of enabling the wireless communication interface by making a setting not to automatically establish connection by the establishment unit.

7. The apparatus according to claim 6, further comprising a storage unit configured to store at least one piece of connection information usable to establish connection to another communication apparatus and a flag indicating whether to automatically attempt to establish connection,
wherein the establishment unit automatically attempts to establish connection to another communication apparatus in accordance with the flag stored in the storage unit, and
the restriction processing is processing of setting the flag not to automatically attempt to establish connection.

8. The apparatus according to claim 7, wherein
the enabling unit temporarily stores the flag indicating whether to automatically attempt to establish connection, and
the enabling unit returns the flag after the transmission unit transmits the connection information.

9. The apparatus according to claim 1, wherein the enabling unit restricts, via an application programming interface of an operating system, establishment of connection via the wireless communication interface.

10. The apparatus according to claim 1, further comprising a storage unit configured to store at least one piece of connection information usable to establish connection to another communication apparatus to which the communication apparatus was connected in the past,
wherein the detection unit detects a state in which the wireless communication interface is not mounted on the communication apparatus, and
the communication apparatus further includes a notification unit configured to make a notification to prompt to connect the wireless communication interface to the communication apparatus in a case where the detection unit detects the state in which the wireless communication interface is not mounted and the storage unit stores the at least one piece of connection information.

11. The apparatus according to claim 1, further comprising an acquisition unit configured to acquire at least one piece of connection information used to perform connection to another communication apparatus to which the communication apparatus is connected via the wireless communication interface,
wherein the transmission unit transmits, to the first other communication apparatus, the connection information usable to establish connection to the second other communication apparatus among the at least one piece of connection information acquired by the acquisition unit.

12. The apparatus according to claim 1, further comprising a decision unit configured to decide, based on a detection result of the detection unit, whether to attempt to establish the wireless connection.

13. The apparatus according to claim 12, wherein in a case where the connection is established by the wireless communication interface, the decision unit decides to attempt to establish the wireless connection.

14. The apparatus according to claim 12, wherein
the detection unit determines a state of a wired communication interface of the communication apparatus, and
in a case where no connection is established by either the wireless communication interface or the wired communication interface, the decision unit decides not to attempt to establish the wireless connection.

15. The apparatus according to claim 14, wherein in a case where connection is established by the wired communication interface and the wireless communication interface is disabled, the decision unit decides to attempt to establish the wireless connection.

16. The apparatus according to claim 14, wherein in a case where connection is established by the wired communication interface, and the wireless communication interface is enabled but no connection is established, the decision unit decide to attempt to establish the wireless connection.

17. A control method executed by a communication apparatus, comprising:
detecting a state of a wireless communication interface of the communication apparatus;
enabling the wireless communication interface by executing restriction processing of restricting establishment of connection via the wireless communication interface in a case where a state in which the wireless communication interface is disabled is detected;
establishing wireless connection to a first another communication apparatus via the enabled wireless communication interface; and
transmitting, to the first other communication apparatus, via the wireless connection, connection information usable for connection to a second another communication apparatus different from the first other communication apparatus.

18. A non-transitory computer-readable storage medium storing a program, wherein the program causes a computer of a communication apparatus to function as:
a detection unit configured to detect a state of a wireless communication interface of the communication apparatus;
an enabling unit configured to enable the wireless communication interface by executing restriction processing of restricting establishment of connection via the wireless communication interface in a case where the detection unit detects a state in which the wireless communication interface is disabled;
an establishment unit configured to establish wireless connection to a first another communication apparatus via the enabled wireless communication interface; and
a transmission unit configured to transmit, to the first other communication apparatus, via the wireless connection, connection information usable for connection to a second another communication apparatus different from the first other communication apparatus.
